(19) United States
(12) Patent Application Publication
(10) Pub. No.: US 2013/0036913 A1
(43) Pub. Date: Feb. 14, 2013

(54) DESICCANT AIR CONDITIONER

(71) Applicant: Jiro Fukudome, Osaka-shi (JP)

(72) Inventor: Jiro Fukudome, Osaka-shi (JP)

(73) Assignee: YANMAR CO., LTD., Osaka-shi (JP)

(21) Appl. No.: 13/583,354

(22) PCT Filed: Mar. 9, 2011
(86) PCT No.: PCT/JP2011/055545

§ 371 Date: Sep. 7, 2012

(30) Foreign Application Priority Data
Mar. 11, 2010 (JP) 2010-054802

(51) Int. Cl. B01D 53/28

(52) U.S. Cl. 96/118

(57) ABSTRACT

Provided is an air conditioning system capable of high efficiency operation and a compact structure. The air conditioning system is provided with a desiccant and a heat pump. The desiccant absorbs air moisture and the heat pump employs the treating air as a low-temperature heat source while employing the reproducing air as a high-temperature heat source to supply reproducing air with heat for reproducing the desiccant. Heat exchange occurs between the reproducing air before being heated by the heat pump.

### TECHNICAL FIELD

The present invention relates to a desiccant air conditioner using dehumidification or humidification and sensible heat exchange.

### BACKGROUND ART

Since a desiccant air conditioner, unlike a cooling dehumidification type, cools air after dehumidifying the air, mold or bacteria cannot propagate, and the desiccant air conditioner may not use Freon, so the desiccant air conditioner is spotlighted as the future air conditioner.

FIG. 9 shows the configuration of a common desiccant air conditioner a. That is, the desiccant air conditioner is configured by disposing an introduction line b allowing air SA to flow into a room from the outside and a discharge line c allowing air RA to flow to the outside from the room in an adjacent countercurrent state such that the air SA and RA flows in opposite directions, and by disposing a desiccant rotor d and a sensible heat rotor e across the introduction line b and the discharge line c. Further, the air SA flowing into the introduction line b from the outside is dehumidified by the desiccant rotor d, cooled by the sensible heat rotor d, and then supplied into the room. Meanwhile, the air RA flowing into the discharge line c from the room has heat taken by the sensible heat rotor e. In addition, the air RA is further heated by a heater f, absorbs moisture from the desiccant rotor d, and then is discharged to the outside.

In this process, the desiccant rotor d is made of a bibulous material in a disk shape with air permeability and disposed perpendicular to the flows of the air SA and RA in the introduction line b and the discharge line c, and is configured to repeat absorption (moisture absorption) and desorption (moisture desoprtion) by coming in contact with the air SA and RA passing through the introduction line b and the discharge line c while rotating. That is, the desiccant rotor d absorbs moisture from the air SA passing through the introduction line b, but when the rotor d moves to the discharge line c by rotating, the rotor d discharges the moisture to the air RA passing through the discharge line c to be dried and has dehumidifying ability regenerated, and then the desiccant rotor d moves to the introduction line b by rotating and repeats the same operations.

The desiccant air conditioner a has a limitation in the ability of controlling the humidity or temperature, because the dehumidifying ability depends on the performance of the desiccant rotor d. In particular, since the desiccant rotor d generates moisture absorption heat when absorbing moisture from the air SA passing through the introduction line b, the moisture absorption ability is deteriorated, so there is a limitation in increasing dryness.

For this reason, according to the related art, in order to improve dehumidifying ability of the desiccant rotor, for example, as disclosed in Patent Document 1, a desiccant air conditioner using a desiccant rotor having two dehumidification sections through which air in an introduction line passes and one regeneration section through which air in a discharge line passes has been proposed.

In the desiccant air conditioner, the air in the introduction line is introduced into the desiccant rotor and dehumidified in a first dehumidification section, and is introduced to a heat exchanger and cooled by exchanging heat with air from the discharge line, and is introduced to the desiccant rotor and dehumidified in a second dehumidification section, and is cooled by exchanging heat with a cold source of a heat pump, and then is supplied into a room. Further, the air from the discharge line is heated by exchanging heat with the air from the introduction line and further heated by a heat source of the heat pump, and then is introduced to the desiccant rotor and heats the regeneration section to remove moisture held in the regeneration section, thereby regenerating the moisture absorption ability of the desiccant rotor.

Further, as another desiccant air conditioner, as disclosed in Patent Document 2, a desiccant air conditioner using a desiccant rotor having one dehumidification section through which air in an introduction line passes and two regeneration sections through which air in a discharge line passes has been proposed.

In the above desiccant air conditioner, the air in the introduction line is introduced into the desiccant rotor and dehumidified in a dehumidification section, and is introduced to a heat exchanger and cooled by exchanging heat with air from the discharge line, and is cooled by exchanging heat with a cold source of a heat pump, and then is supplied into a room. Further, the air from the discharge line is heated by exchanging heat with the air from the introduction line and further heated by a heat source of the heat pump, and then divided into two lines, thereafter, the air passing through one division line is introduced to the desiccant rotor and heats a first regeneration section to remove moisture held in the first regeneration section, thereby regenerating the moisture absorption ability of the desiccant rotor. The air passing through the other division line is further heated by the heat source of the heat pump, and then introduced to the desiccant rotor to heat a second regeneration section.

### PATENT DOCUMENTS

Patent Document 1: Japanese Unexamined Patent Publication No. Hei 9-318129

Patent Document 1: Japanese Unexamined Patent Publication No. Hei 10-267576

### DISCLOSURE OF THE INVENTION

### Technical Problem

However, in the desiccant air conditioner disclosed in Patent Document 1, since the first dehumidification section and the second dehumidification section are adjacent to each other, the first dehumidification section is moved to the second dehumidification section by the rotation of the desiccant rotor, with the dehumidifying ability decreased by the air passing through the first dehumidification section from the introduction line, so the air from the introduction line cannot be provided with sufficient dehumidifying ability from the desiccant rotor when passing through the second dehumidification section.

Further, in the desiccant air conditioner of Patent Document 2, the first regeneration section is moved to the second regeneration section by the rotation of the desiccant rotor, with the dehumidifying ability regenerated by the passage of the air through one division line heated by the heat source of the heat pump. Therefore, it is necessary to further heat the air passing through the other division line with the heat source of the heat pump in order to obtain sufficient dehumidifying ability from the desiccant rotor in the second regeneration section, so the structure is complicated. Further, even if the air passing through the other division line is further heated by the heat source of the heat pump, as the air from the discharge line is divided into two regeneration sections, the flow rate of the air may decrease in the regeneration sections, so it is difficult to obtain sufficient regenerating ability.

The present invention has been made in consideration of the above situations and it is an object of the present invention to provide a desiccant air conditioner that can efficiently show dehumidifying ability of a desiccant rotor with a simple configuration.

### Means for Solving the Problem

In order to solve the above problems, a desiccant air conditioner according to the present invention includes: an introduction line allowing air to be introduced into a room from an outside; a discharge line allowing the air in the room to be discharged to the outside; a desiccant rotor performing dehumidification by absorbing moisture from the air flowing through the introduction line and regenerating dehumidifying ability by discharging moisture to the air flowing through the discharge line; a heating heat exchanger for heating the air in the discharge line; a sensible heat exchanger allowing heat exchange between the air flowing through the introduction line and the air flowing through the discharge line; and a controller controlling the introduction line, the discharge line, the desiccant rotor, the heating heat exchanger, and the sensible heat exchanger, in which two humidity control sections through which the air from the introduction line passes and two regeneration sections through which the air from the discharge line passes are alternately formed in the desiccant rotor, the air flowing through the introduction line flows through the two moisture control sections in series and the air flowing through the discharge line flows through the two regeneration sections in series, and the controller changes the rotational direction of the desiccant rotor into opposite directions based on operations of cooling dehumidification and heating humidification.

In order to solve the problems, a desiccant air conditioner according to the present invention includes: an introduction line allowing air to be introduced into a room from an outside; a discharge line allowing the air in the room to be discharged to the outside; a desiccant rotor performing dehumidification by absorbing moisture from the air flowing through the introduction line and regenerating dehumidifying ability by discharging moisture to the air flowing through the discharge line; a heating heat exchanger for heating the air in the discharge line; a sensible heat exchanger allowing heat exchange between the air flowing through the introduction line and the air flowing through the discharge line; and a controller controlling the introduction line, the discharge line, the desiccant rotor, the heating heat exchanger, and the sensible heat exchanger, in which two humidity control sections through which the air from the introduction line passes and two regeneration sections through which the air from the discharge line passes are alternately formed in the desiccant rotor, the air flowing through the introduction line flows through the two moisture control sections in series and the air flowing through the discharge line flows through the two regeneration sections in series, and the controller changes the rotation speed of the desiccant rotor based on operations of cooling dehumidification and heating humidification.

In order to solve the problems, a desiccant air conditioner according to the present invention includes: an introduction line allowing air to be introduced in a room from an outside; a discharge line allowing the air in the room to be discharged to the outside; a desiccant rotor performing dehumidification by absorbing moisture from the air flowing through the introduction line and regenerating dehumidifying ability by discharging moisture to the air flowing through the discharge line; a heating heat exchanger for heating the air in the discharge line; and a sensible heat exchanger allowing heat exchange between the air flowing through the introduction line and the air flowing through the discharge line, in which two humidity control sections through which the air from the introduction line passes and two regeneration sections through which the air from the discharge line passes are alternately formed in the desiccant rotor, the air flowing through the introduction line flows through the two moisture control sections in series and the air flowing through the discharge line flows through the two regeneration sections in series, and a cooling heat exchanger is disposed between the moisture control section located at an upstream side of the introduction line and the moisture control section located at a downstream side of the introduction line to decrease a temperature of the air from the moisture control section located at the upstream side by exchanging heat with cold water or low-temperature refrigerant.

In order to solve the problems, a desiccant air conditioner according to the present invention includes: an introduction line allowing air to be introduced into a room from an outside; a discharge line allowing the air in the room to be discharged to the outside; a desiccant rotor performing dehumidification by absorbing moisture from the air flowing through the introduction line and regenerating dehumidifying ability by discharging moisture to the air flowing through the discharge line; a heating heat exchanger for heating the air in the discharge line; and a sensible heat exchanger allowing heat exchange between the air flowing through the introduction line and the air flowing through the discharge line, in which two humidity control sections through which the air from the introduction line passes and two regeneration sections through which the air from the discharge line passes are alternately formed in the desiccant rotor, and the air flowing through the introduction line flows through the two moisture control sections in series and the air flowing through the discharge line is heated by the heating heat exchanger and then is divided to flow through the two regeneration sections in parallel.

In order to solve the problems, a desiccant air conditioner according to the present invention includes: an introduction line allowing air to be introduced into a room from an outside; a discharge line allowing the air in the room to be discharged to the outside; a desiccant rotor performing dehumidification by absorbing moisture from the air flowing through the introduction line and regenerating dehumidifying ability by discharging moisture to the air flowing through the discharge line; a heating heat exchanger for heating the air in the discharge line; and a sensible heat exchanger allowing heat exchange between the air flowing through the introduction line and the air flowing through the discharge line, in which two humidity control sections through which the air from the introduction line passes and two regeneration sections through which the air from the discharge line passes are alternately formed in the desiccant rotor, the air flowing through the introduction line flows through the two moisture control sections in series and the air flowing through the discharge line flows through the two regeneration sections in series, and a size of the regeneration sections is smaller than a size of the moisture control sections, in the desiccant rotor.

In order to solve the problems, a desiccant air conditioner according to the present invention includes: an introduction line allowing air to be introduced into a room from an outside; a discharge line allowing the air in the room to be discharged to the outside; a desiccant rotor performing dehumidification by absorbing moisture from the air flowing through the introduction line and regenerating dehumidifying ability by discharging moisture to the air flowing through the discharge line; a heating heat exchanger for heating the air in the discharge line; a sensible heat exchanger allowing heat exchange between the air flowing through the introduction line and the air flowing through the discharge line; and a controller controlling the introduction line, the discharge line, the desiccant rotor, the heating heat exchanger, and the sensible heat exchanger, in which the controller controls heating or evaporating for condensed drain, which is generated when the air flowing through the discharge line is cooled by the sensible heat exchanger, by supplying hot water to the heating heat exchanger disposed for a cooling dehumidification operation, in a heating humidification operation.

### Effect of the Invention

As described above, according to the present invention, it is possible to efficiently show ability of a desiccant rotor.

### BRIEF DESCRIPTION OF THE DRAWINGS

FIG. 1(a) is a schematic configuration view in a vertical cross-section of a desiccant air conditioner according to the present invention and FIG. 1(b) is a schematic configuration view in a vertical cross-section of the desiccant air conditioner.

FIG. 2 is a refrigerant circuit diagram schematically illustrating the entire configuration of a desiccant air conditioner according to the present invention.

FIG. 3 is a psychrometric diagram showing properties of discharged air and introduced air in a cooling operation of a desiccant air conditioner according to the present invention.

FIG. 4(a) is a graph showing the relationship between dehumidifying ability and the temperature of air passing through a desiccant rotor due to a difference in rotational direction of the desiccant rotor in cooing and FIG. 4(b) is a graph showing the relationship between humidifying ability and the temperature of air passing through the desiccant rotor due to a difference in rotational direction of the desiccant rotor in heating.

FIG. 5(a) is a graph showing the relationship between cooling dehumidification efficiency and the number of rotations of a desiccant rotor in cooling and FIG. 5(b) is a graph showing the relationship between heating humidification efficiency and the number of rotations of a desiccant rotator in heating.

FIG. 6 is a refrigerant circuit diagram schematically illustrating the entire configuration of a desiccant air conditioner according to another embodiment of the present invention.

FIG. 7 is a refrigerant circuit diagram schematically illustrating the entire configuration of a desiccant air conditioner according to another embodiment of the present invention.

FIG. 8(a) is a plan view showing a common desiccant rotor used in the desiccant rotor of the present invention and FIG. 8(b) is a plan view showing a desiccant rotor of another embodiment used in the desiccant rotor of the present invention.

FIG. 9 is a schematic illustrative view showing the entire configuration of a desiccant air conditioner of the related art.

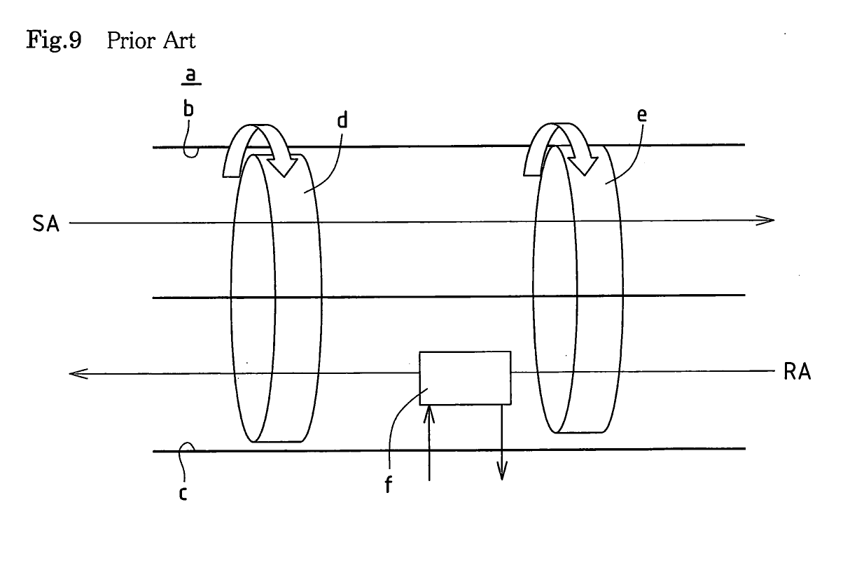

### EMBODIMENTS FOR CARRYING OUT THE INVENTION

Hereinafter, embodiments of the present invention will be described with reference to the accompanying drawings.

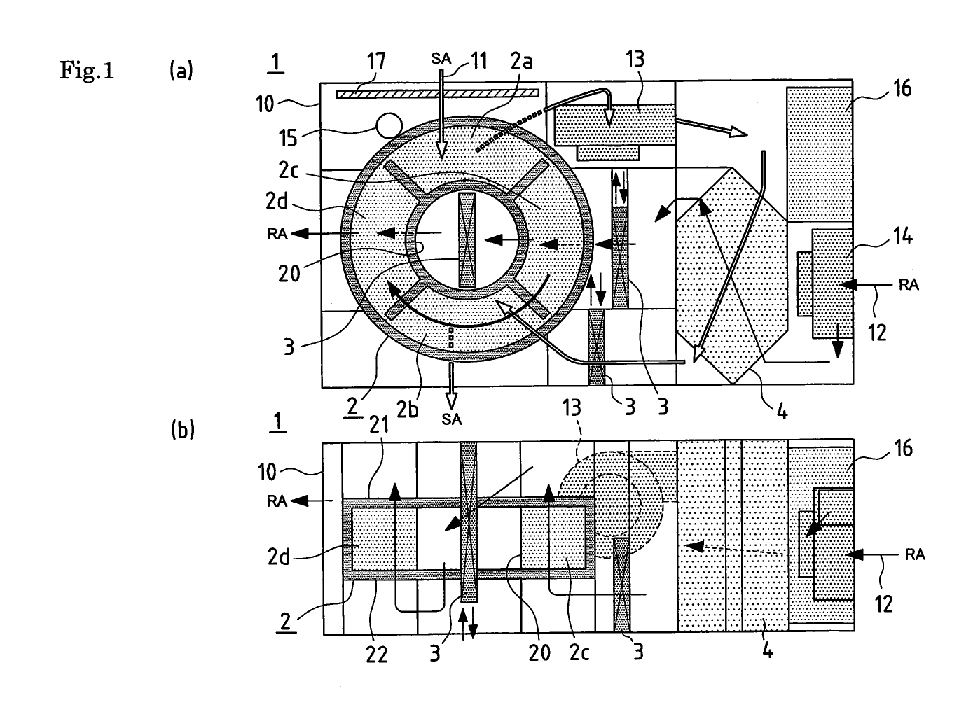

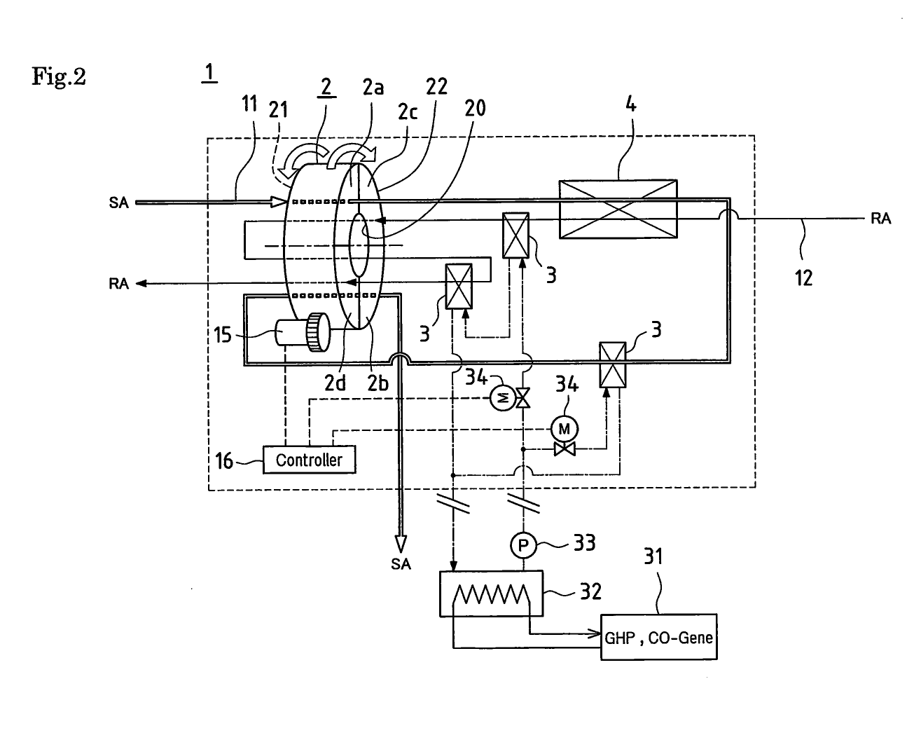

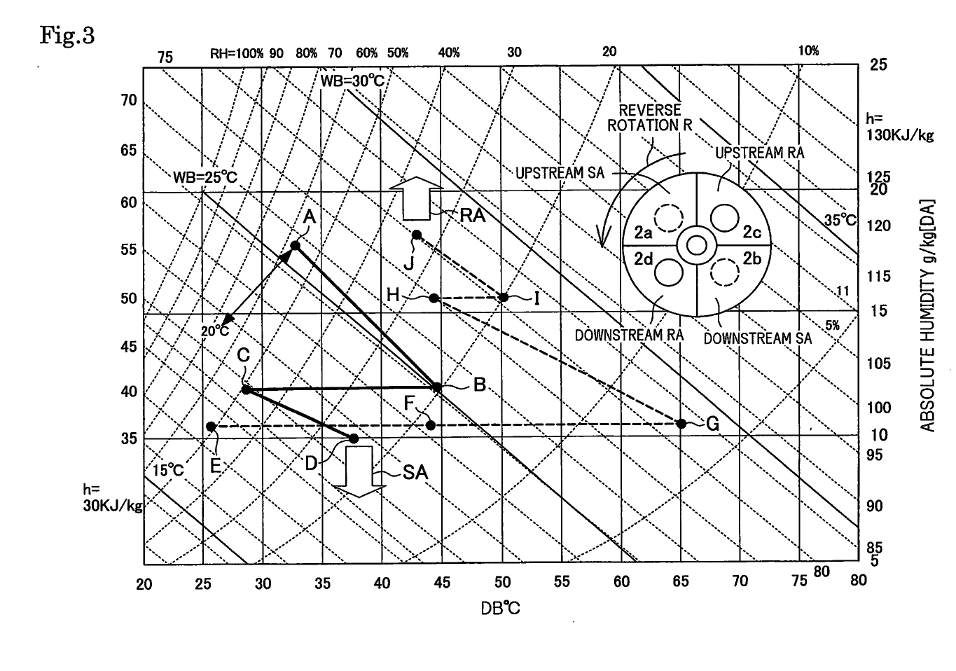

FIG. 1 schematically shows the entire configuration of a desiccant air conditioner 1 according to the present invention, FIG. 2 shows a refrigerant circuit diagram of the desiccant air conditioner 1, and FIG. 3 shows a psychrometric diagram when the desiccant air conditioner operates in a cooling mode.

In detail, the desiccant air conditioner 1 includes an introduction line 11 allowing air SA to be introduced into a room from an outside, a discharge line 12 allowing air RA in the room to be discharged to the outside, a desiccant rotor 2 performing dehumidification by absorbing moisture from the air SA flowing through the introduction line 11 and regenerating dehumidifying ability by discharging moisture to the air RA flowing through the discharge line 12, a heating heat exchanger 3 for heating the air RA in the discharge line 12, and a sensible heat exchanger 4 allowing heat exchange between the air SA flowing through the introduction line 11 and the air RA flowing through the discharge line 12, in which a first humidity control section 2a and a second humidity control section 2b through which the air SA in the introduction line 11 passes, and a first regeneration section 2c and a second regeneration section 2d through which the air RA in the discharge line 12 passes are alternately disposed in the desiccant rotor 2.

The desiccant air conditioner 1 is received in a casing 10 with a length of 1370 mm, a width of 820 mm, and a height of 460 mm, and the flow of the air SA in introduction line 11 and the air RA in the discharge line 12 are formed by fans 13 and 14 disposed in the introduction line 11 and the discharge line 12, respectively. The desiccant rotor 2 is driven by a motor 15 engaged with the outer circumference of the desiccant rotor 2 such that the desiccant rotor 2 can be freely rotated in forward/reverse directions. Driving the fans 13 and 14 and the motor 15 is controlled by a controller 16. The air SA introduced into the introduction line 11 from the outdoors is purified by a purifying filter 17.

The material of the desiccant rotor 2 is not specifically limited and various materials may be very appropriately used as long as the materials, which are used for common desiccant air conditioners, have absorption and desorption functions. In detail, synthetic silica gel or a cross-linked polyacrylate-based high moisture-absorbing/desorbing material, natural silica alumina-based desiccant, or a ceramic-based desiccant such as molecular sieves may be exemplified. In the above materials, particularly, the cross-linked polyacrylate-based high moisture-absorbing/desorbing material is made of acrylic fiber, which is a raw material, by producing an amide group and a carboxylic acid group by partially hydrolyzing a nitrile group and partially gelatinizing of the nitrile group with hydrazine can show excellent sorption and desorption. The definition is not limited as long as the cross-linked polyacrylate-based high moisture-absorbing/desorbing material is used particularly for this type of desiccant rotor 2, but when a cross-linked polyacrylate-based high moisture-absorbing/desorbing material with the content of nitrogen increased by 1.0˜10.0 wt %, carboxylic acid of 1.0˜5.0 mmol/g, and amide group as the balance is used, it has performance of having pH buffer capacity keeping pH at 7.5˜8.0 and also has antibacterial activity and a function of deodorizing, such that it can be very appropriately used.

The desiccant rotor 2 is formed in a ring shape with a through-passage 20 passing through the desiccant rotor 2 at the center of a disk having a predetermined thickness. The through-passage 20 is configured to allow the air RA to flow from the first regeneration section 2c at the upstream side toward the second regeneration section 2d at the downstream side, with the desiccant rotor 2 disposed in a casing 10. Further, when being disposed in the casing 10, the desiccant rotor 2 is configured such that the moisture control sections 2a and 2b and the regeneration sections 2c and 2d are alternately and circumferentially arranged at an angle of 90° around the center, with the first moisture control section 2a and the second moisture control section 2b opposite to each other and the first regeneration section 2c and the second regeneration section 2d opposite to each other. Further, the introduction line 11 through which the air SA passes and the discharge line 12 through which the air RA passes are formed in the casing 10 such that the air SA passes from one side 21 to the other side 22 of the desiccant rotor 2 in the first moisture control section 2a and the second moisture control section 2b and the air RA passes from the other side 22 to one side 21 of the desiccant rotor 2 in the first regeneration section 2c and the second regeneration section 2d.

The desiccant rotor 2 moves in the order of the first moisture control section 2a, the first regeneration section 2c, the second moisture control section 2b, and the second regeneration section 2d when being driven by the motor 15 to rotate in a normal rotational direction N, and moves in the order of the first moisture control section 2a, the second regeneration section 2d, the second moisture control section 2b, and the first regeneration section 2c when being rotated in a reverse rotational direction R.

The heating heat exchanger 3 is configured such that heat recovered by an engine discharge heat recovery device 32 from the heat source 31 of a cogeneration system or a gas heat pump is supplied in circulation by a pump 33. The heating heat exchanger 3 is disposed at three positions, in which two heating heat exchangers 3 are disposed in the discharge line 12 and one heating heat exchanger 3 is disposed in the introduction line 11. One of the heating heat exchangers 3 disposed in the discharge line 12 is disposed on the path between a sensible heat exchanger 4, which is described below, and the desiccant rotor 2. Further, the other heating heat exchanger 3 is disposed on the path between the first regeneration section 2c and the second regeneration section 2d of the desiccant rotor 2, in the through-passage 20 of the desiccant rotor 2. The heating heat exchanger 3 disposed in the discharge line 11 is disposed on the path between the sensible heat exchanger 4 and the second moisture control section of the desiccant rotor 2. Further, the heating heat exchangers 3 are selectively supplied with heat by opening/closing of electromagnetic valves 34.

The sensible heat exchanger 4 is configured to allow heat exchange between the air SA passing through the introduction line 11 and the air RA passing through the discharge line 12 and is disposed between the discharge line 12 ranging from the room to the heat exchanger 3 and the introduction line 11 ranging from the moisture control section 2a to the heat exchanger 3.

The controller 16 controls the motor 15 that rotates the desiccant rotor 2, opens/closes the paths to the heating heat exchangers 3, controls the pump 33, and controls the fans 13 and 14.

Next, the operation of the desiccant air conditioner 1 having the configuration described above in the cooling mode is described with reference to the psychrometric diagram of FIG. 3. In the cooling mode, the recovered heat is not supplied to the heating heat exchanger 3 disposed in the introduction line 11, but the recovered heat is supplied only to the heating heat exchangers 3 disposed in the discharge line 12. Further, it is assumed that the desiccant rotor 2 rotates in the reverse direction R.

The air SA introduced into the introduction line 11 from the outside (state A) is dehumidified in the first moisture control section 2a of the desiccant rotor 2 and increases in temperature due to absorption heat generated when the moisture in the air SSA is absorbed to the desiccant rotor 2 (state B).

The air SA dehumidified and increased in temperature (state B), as described above, is sent to the sensible heat exchanger 4 and is cooled by exchanging heat with the air RA passing through the discharge line 12 from the room (state C).

The cooled air SA is dehumidified again in the second moisture control section 2b of the desiccant rotor 2 such that the humidity further decreases, and then supplied to the room (state D). In the dehumidification in the second moisture control section 2b, dehumidifying ability is regenerated by removing the moisture absorbed to the desiccant rotor 2 in the second regeneration section 2d (described below) between the dehumidification in the first moisture control section 2a and the dehumidification in the second moisture control section 2b, such that the dehumidification in the second moisture control section 2b can be efficiently performed. Further, in the dehumidification in the second moisture control section 2b, the air SA increases in temperature due to the absorption heat, but the temperature of the air SA has already been sufficiently decreased by the dehumidification in the first moisture control section 2a, so the increase in temperature of the air SA due to the absorption heat in the second moisture control section 2b can be suppressed to be lower than the increase in temperature of the air SA due to the absorption heat in the first moisture control section 2a.

Further, in order to further increase cooling ability, it may be possible to supply the air SA after further cooling the air SA that has passed through the second moisture control section 2b with a cooler (not shown) in another heat pump cycle. Further, in this case, it may be possible to switch the cooler (not shown) and the sensible heat exchanger 4 such that the order of cooling of the cooler (not shown) and cooling of the sensible heat exchanger 4 is reversed.

Meanwhile, the air RA introduced into the discharge line 12 (state E) increases in temperature by cooling the air SA, which is sent to the sensible heat exchanger 4 and passes through the introduction line 11 from the outside (state F). The air RA with the temperature increased (state F) is then sent to the heating heat exchanger 3 and heated so that the temperature of the air RA is increased (state G).

The air with the increased temperature (state G) removes the moisture absorbed to the desiccant rotor 2 while passing through the second regeneration section 2c of the desiccant rotor 2, thereby regenerating the desiccant rotor 2.

The air RA absorbing moisture (state H) by the regeneration is then further heated by another heating heat exchanger 3 (state I), passes the second regeneration section 2d, and regenerates the desiccant rotor 2 by removing moisture absorbed in the desiccant rotor 2 even in the second regeneration section 2d. The air RA absorbing moisture after regenerating (state J) is discharged to the outside.

In this process, since the desiccant rotor 2 moves in the order of the first moisture control section 2a, the second regeneration section 2d, the second moisture control section 2b, and the first regeneration section 2c while being rotated in the reverse direction R by the rotation of the motor 15, the desiccant rotor 2 passed the second moisture control section 2b can be regenerated in the first regeneration section 2c and the desiccant rotor 2 passed the first moisture control section 2a can be regenerated in the second regeneration section 2d, therefore, the air RA cannot sequentially pass through the first regeneration section 2c and the second regeneration section 2d, so it is possible to efficiently regenerate the desiccant rotor 2 through two steps of regeneration.

Further, the air SA passing through the introduction line 11 is dehumidified in the first moisture control section 2a by the desiccant rotor 2 regenerated by the first regeneration section 2c and dehumidified in the second moisture control section 2b by the desiccant rotor 2 regenerated in the second regeneration section 2d; therefore, the air cannot sequentially pass through the first moisture control section 2a and the second moisture control section 2b, so it is possible to efficiently dehumidify through two steps of dehumidification.

The effects of two steps of regeneration and two steps of dehumidification in the cooling mode described above can be achieved not only when the desiccant rotor 2 is rotated in the reverse direction R, but when the desiccant rotor 2 is rotated in the normal direction N.

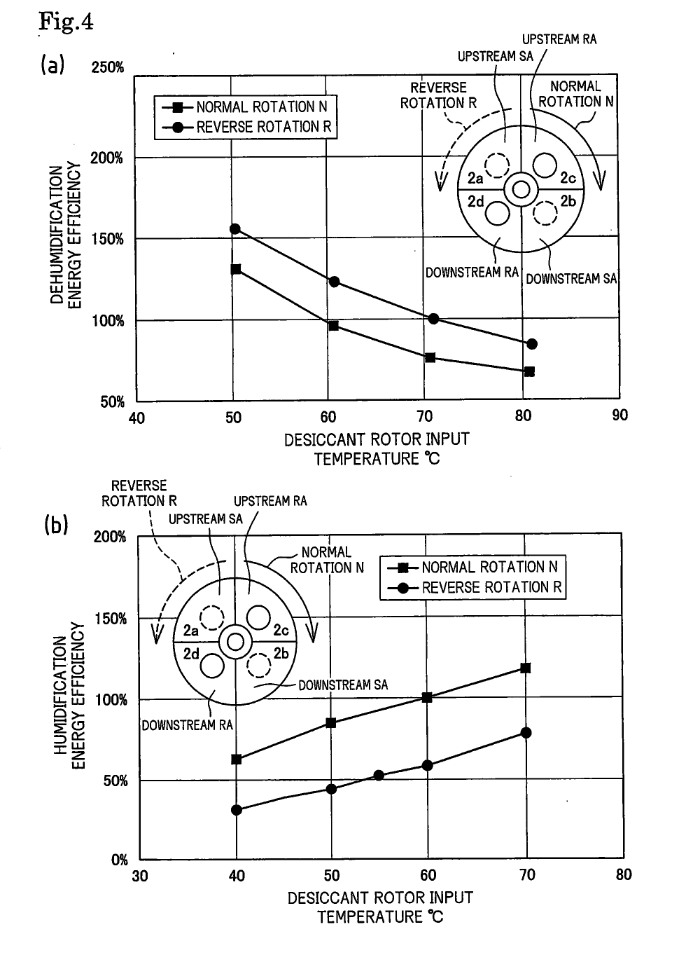

However, as shown in FIG. 4(a), the dehumidification energy efficiency in cooling when the desiccant rotor 2 is rotated in the reverse direction R is better than when the desiccant rotor 2 is rotated in the normal direction N.

Meanwhile, the operation of the desiccant rotor 2 in the heating mode is as follows. That is, in the heating mode, in the desiccant air conditioner 1, the recovered heat is not supplied to the heating heat exchangers 3 disposed in the discharge line 12, but the recovered heat is supplied only to the heating heat exchanger 3 disposed in the introduction line 11.

The air RA introduced into the discharge line 12 from the room is sent to the sensible heat exchanger 4 and cooled by exchanging heat with the low-temperature air SA passing through the introduction line 11 from the outside. The air RA with the temperature relatively increased by the cooling regenerates the first regeneration section 2c and the second regeneration section 2d by discharging moisture to the first regeneration section 2c and the second regeneration section 2d while passing through the first regeneration section 2c and the second regeneration section 2d of the desiccant rotor 2, and is then discharged to the outside. Meanwhile, the low-temperature air SA introduced into the introduction line 11 from the outside is sent to the sensible heat exchanger 4 through the first moisture control section 2a of the desiccant rotor 2 and heated by exchanging heat with the air RA passing through the discharge line 12 from the room. The air SA with the increased temperature is then sent to the heating heat exchanger 3 to be heated and increases in temperature. The air SA with the temperature increased is humidified by absorbing the moisture absorbed to the desiccant rotor 2 while passing through the second moisture control section 2b of the desiccant rotor 2, and then supplied to the room.

As described above, in the heating mode, it is possible to humidify the air SA supplied to the room from the introduction line 11 in the first moisture control section 2a and the second moisture control section 2b by recovering the moisture in the air RA discharged from the discharge line 12, only by switching the heating heat exchangers 3 without changing the air flow path from the cooling mode.

The effects of two steps of regeneration and two steps of humidification in heating described above can be achieved not only when the desiccant rotor 2 is rotated in the reverse direction R, but when the desiccant rotor 2 is rotated in the normal direction N.

However, as shown in FIG. 4(b), to the contrary of the cooling mode described above, the humidification energy efficiency in the heating mode when the desiccant rotor 2 is rotated in the normal direction N is better than when the desiccant rotor 2 is rotated in the reverse direction R.

Therefore, it is possible to improve the cooling and heating efficiencies by rotating the desiccant rotor 2 in the reverse direction R in the cooling mode and rotating the desiccant rotor 2 in the normal direction N in the heating mode, respectively, when controlling the motor 15 with the controller 16.

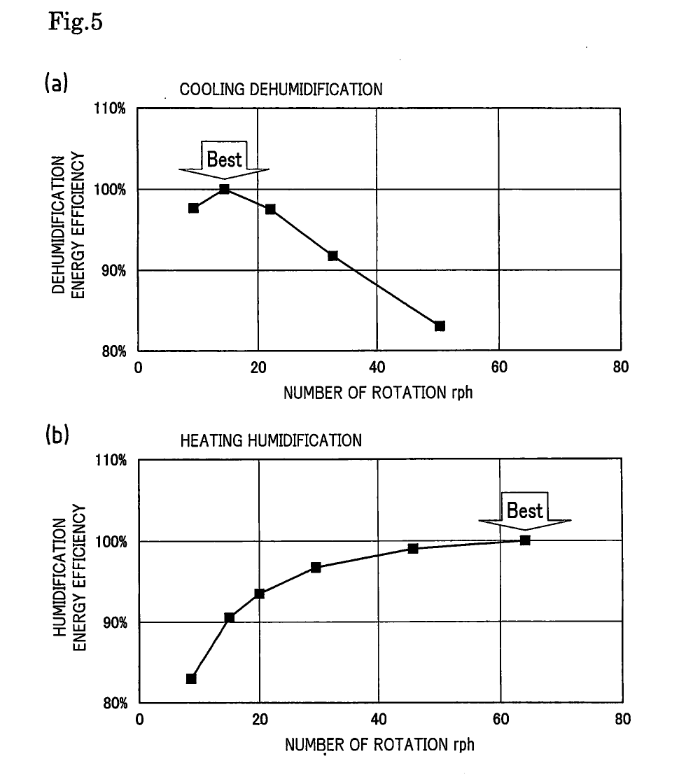

Further, FIG. 5(a) shows the relationship between dehumidification efficiency in the cooling mode and the number of rotations of the desiccant rotor 2 in the desiccant air conditioner 1 and FIG. 5(b) shows the relationship between the humidification efficiency in the heating mode and the number of rotations of the desiccant rotor 2 in the desiccant air conditioner 1. As can be seen from the graphs, the numbers of rotations of the desiccant rotor 2 when the most efficient operation is performed are different in the cooling and heating modes. Therefore, the desiccant rotor 2 is controlled to the most appropriate numbers of rotations for cooling and heating when the motor 15 is controlled by the controller 16. Accordingly, the rotation of the desiccant rotor 2 become optimum for each of cooling and heating modes, so it is possible to improve the cooling/heating efficiency. The control may be feedback control following a control map that is constructed in advance or only programmed control may be performed.

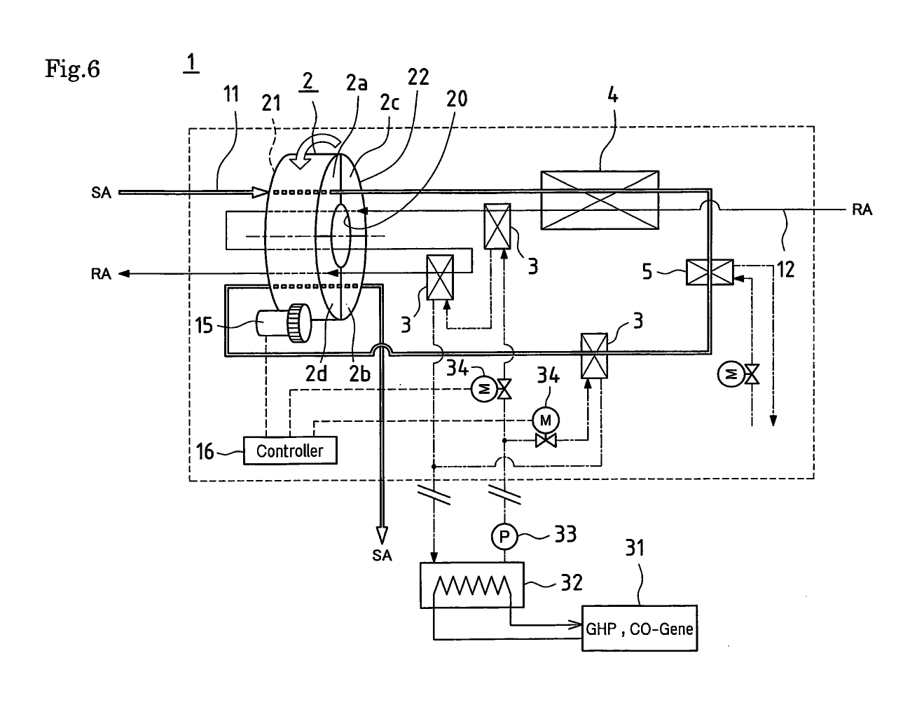

FIG. 6 shows another embodiment of the desiccant air conditioner 1 according to the present invention. That is, the desiccant air conditioner 1 includes an introduction line 11 between the first moisture control section 2a and the second moisture control section 2b and a cooling heat exchanger 5 configured such that cold water or low-temperature refrigerant flows therethrough at the downstream side from the sensible heat exchanger 4. As the cooling heat exchanger 5 is provided, it is possible to further decrease the temperature of the air SA, so it is possible to improve dehumidifying ability in the second moisture control section 2b, and accordingly, it is possible to supply cold air that is further dehumidified to the room. In this case, the cold water or the low-temperature refrigerant flowing through the cooling heat exchanger 5 may be supplied from another heat pump cycle or may be exclusively provided.

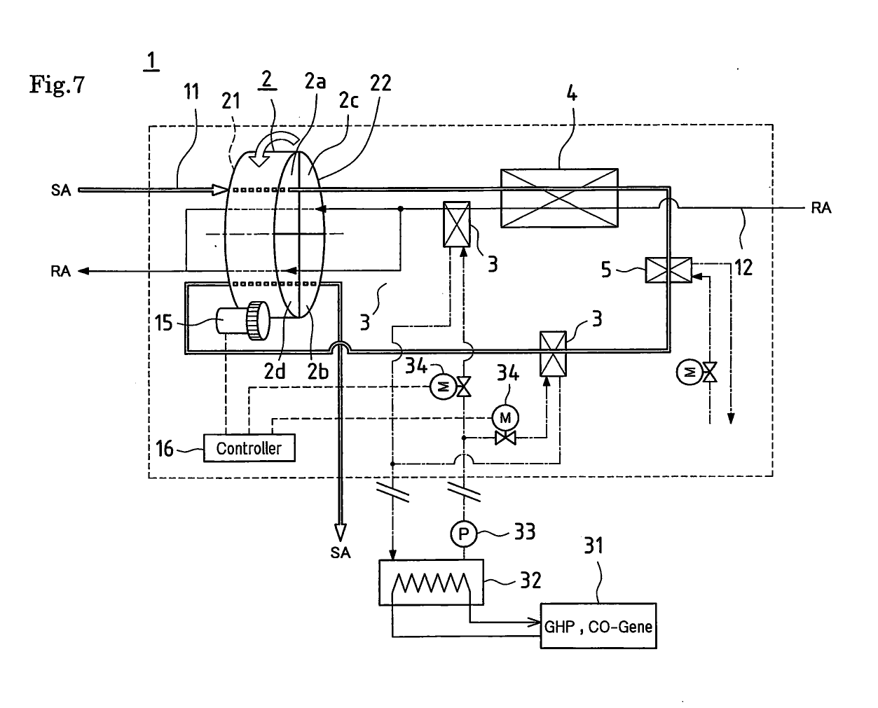

FIG. 7 shows another embodiment of the desiccant air conditioner 1 according to the present invention. That is, in the desiccant air conditioner 1, the discharge line 12 is divided such that the air in the discharge line 12 which has passed through the sensible heat exchanger 4 and the heating heat exchanger 3 is divided in parallel to flow into the first regeneration section 2c and the second regeneration section 2d. In this configuration, as compared with the desiccant air conditioner 1 provided with the heating heat exchanger 3 at the upstream side of the first regeneration section 2c and the second regeneration section 2d, which are connected in series (see FIG. 2), it is possible to reduce the number of the heating heat exchanger 3 from three to two and the discharge line 12 is simply configured, so it is possible to reduce the size and the cost of the apparatus. For example, as shown in the figures, it is possible to make the desiccant rotor 2 not in the ring shape with the through-passage 20, but a disk shape. Although having only one heating heat exchanger 3, as compared with the desiccant air conditioner 1 shown in FIG. 2, the desiccant air conditioner 1 can be efficiently used, when it is used for a relatively small amount of necessary dehumidification, when the temperature of the air RA heated while passing through the discharge line 12 is sufficiently high, or when it is possible to sufficiently ensure the flow rate of the air RA passing through the discharge line 12.

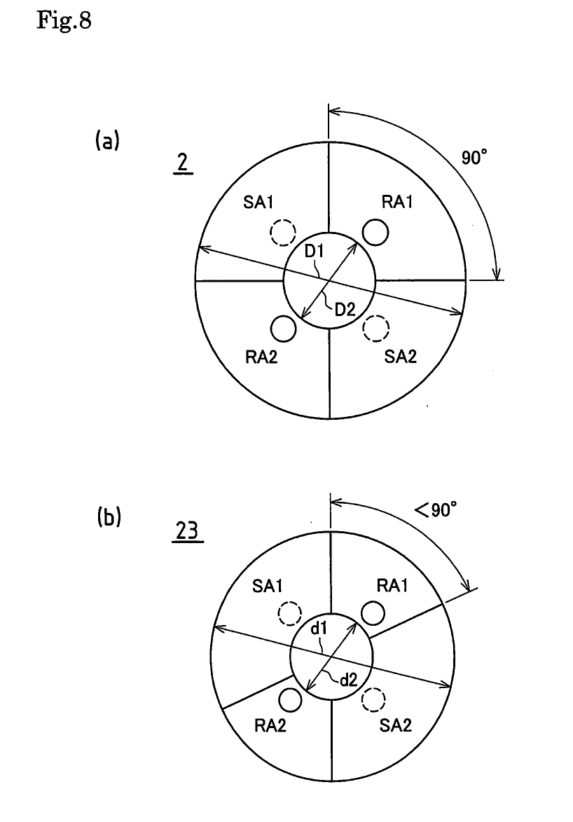

FIG. 8 shows a common desiccant rotor 2 (see FIG. 8(a)), which is used in the desiccant air conditioner 1 according to the present invention, and a small-sized desiccant rotor 23 (see FIG. 8(b)). The central angle of the small-sized desiccant rotor 23 is set less than 90° such that a first moisture control section 2a and a second moisture control section 2b are smaller than a first regeneration section 2c and a second regeneration section 2d. Therefore, in the small-sized desiccant rotor 23, the first regeneration section 2c and the second regeneration section 2d can be increased in size, so it is possible to ensure the first regeneration section 2c and the second regeneration section 2d, which are the same in size as those of the common desiccant rotor 2, even if the entire size is reduced by making the outer diameter d1 and the inner diameter d2 of the small-sized desiccant rotor 23 smaller than the outer diameter D1 and the inner diameter D2 of the common desiccant rotor 2. Therefore, it is possible to reduce the entire size of the desiccant air conditioner 1, which makes it possible to reduce the flow rate of the air RA flowing through the discharge line 12 because it is possible to sufficiently heat the air at sufficiently high temperature, by using the small-sized desiccant rotor 23.

As described above, since the excellent dehumidifying ability and regenerating ability of the desiccant rotor 2 by the desiccant air conditioner 1 can be simply achieved only by the configuration of the channels, the introduction line 11 for supplying the air SA to the first moisture control section 2a and the second moisture control section 2b and the discharge line 12 for supplying the air RA to the first regeneration section 2c and the second regeneration section 2d, it is possible to make a small-sized desiccant air conditioner, as described above, which can be installed in a space, for example, under the roof of a house, under the floor, and inside the walls. Further, the size of the desiccant air conditioner 1 is not specifically limited and may be appropriately designed in accordance with the air-conditioning ability or the amount of wind which is required for the indoor environment. Further, in the desiccant air conditioner 1 shown in FIG. 1, as the through-passage 20 formed in the desiccant rotor 2 is configured to allow the air RA to flow from the first regeneration section 2c at the upstream side toward the second regeneration section 2d at the downstream side and the heating heat exchanger 3 is disposed in the through-passage 20, the fluid path for the air can be simplified and the heating heat exchanger 3 can be easily installed, so it is possible to achieve a more compact design.

Further, in the configuration of the desiccant air conditioner 1 shown in FIG. 1, in the heating operation, the air RA introduced into the discharge line 12 from the room is sent to the sensible heat exchanger 4 and cooled by exchanging heat with the low-temperature air SA passing through the introduction line 11 from the outside. The air RA of which the relative humidity is increased by the cooling may generate drain by condensing, in the range until it is introduced into the first regeneration section 2c of the desiccant rotor 2 from the sensible heat exchanger 4. Accordingly, when drain is generated, it is possible to heat or evaporate the drain by supplying hot water to the heating heat exchanger 3 at the position. In this process, the controller 16 may operate the heating heat exchanger 3 at each predetermined time by using a timer or may operate the heating heat exchanger 3 when detecting the drain. When detecting drain, it may be possible to detect generation of the drain on the basis of data constructed in advance, such as temperature or humidity conditions where the drain is generated, or may directly detect generation of the drain by using a sensor or the like. Further, in the configuration of the desiccant air conditioner 1 shown in FIG. 2, since the heating heat exchanger 3 disposed in the path between the sensible heat exchanger 4 and the desiccant rotor 2 is connected in series with the heating heat exchanger 3 disposed in the through-passage 20 of the desiccant rotor 2, the two heating heat exchangers 3 are connected in parallel in order to supply hot water only to the heat exchanger 3 disposed on the path between the sensible heat exchanger 4 and the desiccant rotor 2.

Further, in the present embodiment, although the heating heat exchanger 3 is configured such that the heat recovered by the engine discharge heat recovery device 32 is supplied in circulation by the pump 33 from the heat source 31 of a cogeneration system or a gas heat pump, the heating heat exchanger 3 is not specifically limited as long as it can heat the air SA in the introduction line 11 or the air RA in the discharge line 12, and may be an electric heater (not shown) or a gas burner (not shown).

The present invention may be implemented in various ways without departing from the spirit or the main features. Therefore, the embodiment described above is only a simple example in all respects and should not be construed in a limitative way. The scope of the present invention is defined by claims and not limited to the specification. Further, changes and modifications included in a range equivalent to claims are all included in the scope of the present invention.

### INDUSTRIAL APPLICABILITY

The present invention can be used for a desiccant air conditioner.

1. A desiccant air conditioner comprising:
an introduction line allowing air to be introduced into a room from an outside;
a discharge line allowing the air in the room to be discharged to the outside;
a desiccant rotor performing dehumidification by absorbing moisture from the air flowing through the introduction line and regenerating dehumidifying ability by discharging moisture to the air flowing through the discharge line;
a heating heat exchanger for heating the air in the discharge line; and
a sensible heat exchanger allowing heat exchange between the air flowing through the introduction line and the air flowing through the discharge line,
wherein two humidity control sections through which the air from the introduction line passes and two regeneration sections through which the air from the discharge line passes are alternately formed and a through-passage is formed at a center, in the desiccant rotor, and
the air flowing through the introduction line flows through the two moisture control sections in series and the air flowing through the discharge line flows through the two regeneration sections in series,
by flowing through the through-passage.

2. The desiccant air conditioner:
of claim 1, further comprising a controller that inversely changes a rotational direction of the desiccant rotor based on operations of cooling dehumidification and heating humidification.

3. The desiccant air conditioner
of claim 1, further comprising a controller that changes a rotation speed of the desiccant rotor based on operations of cooling dehumidification and heating humidification.

4. The desiccant air conditioner
of claim 1, wherein a cooling heat exchanger that decreases a temperature of the air from the moisture control section at an upstream side by exchanging heat with cold water or low-temperature refrigerant is disposed between the moisture control section at the upstream side and the moisture control section at a downstream side in the introduction line.

5. The desiccant air conditioner
of claim 1, wherein a size of the regeneration sections is smaller than a size of the moisture control sections in the desiccant rotor.

6. The desiccant air conditioner
of claim 1, further comprising a controller that controls heating or evaporating for condensed drain, which is generated when the air flowing through the discharge line is cooled by the sensible heat exchanger, by supplying hot water to the heating heat exchanger disposed for a cooling dehumidification operation, in a heating humidification operation.
